(19) United States
(12) Patent Application Publication
(10) Pub. No.: US 2022/0200346 A1
(43) Pub. Date: Jun. 23, 2022

(54) CHARGER WITH REMOVABLE PARTS

(71) Applicant: Primax Electronics Ltd., Taipei (TW)

(72) Inventor: Bo-An Chen, Taipei (TW)

(21) Appl. No.: 17/184,125

(22) Filed: Feb. 24, 2021

(30) Foreign Application Priority Data
Dec. 23, 2020 (TW) 109145825

(51) Int. Cl. H02J 50/12; H02J 50/00

(52) U.S. Cl. CPC H02J 50/12; H02J 50/005

(57) ABSTRACT

A charger with a removable magnetic assembly is provided. The charger includes a main body, a wireless charging module, a receiving recess and a covering member. The wireless charging module is disposed within the main body. The receiving recess is concavely formed in the top surface of the main body. The covering member is detachably disposed on the top surface of the main body to cover the receiving recess. When the covering member is detached from the top surface of the main body, the receiving recess is exposed outside. Consequently, the magnetic assembly is selectively placed into the receiving recess or removed from the receiving recess.

### FIELD OF THE INVENTION

The present invention relates to a charging device, and more particularly to a charger with movable parts.

### BACKGROUND OF THE INVENTION

As known, when a portable electronic device is in the usage state, the portable electronic device continuously consumes power. In case that the electric quantity is too low, a charger is required to provide electric energy to the electronic device to supplement the consumed electric energy in use. As the demands on chargers increase, a variety of chargers have been developed. For example, the wireless charger has been widely used. Generally, the wireless charger comprises a built-in wireless charging module corresponding to an inner induction coil of a portable electronic device. When the wireless charging module and the induction coil approach each other, the magnetic field is changed and transformed into electric energy. The electric energy is transmitted from the wireless charger to the portable electronic device in order to charge the portable electronic device.

In accordance with a feature of the wireless charger, the position of the wireless charging module and the position of the induction coil need to be close to each other in a specified range in order to generate the magnetic field change. If the distance between the wireless charging module and the induction coil is too far or the wireless charging module and the induction coil are not effectively aligned with each other, the charging operation is unable to be done or the charging efficiency is not satisfactory. For solving the above drawbacks, the wireless charger and the portable electronic device have respective magnetic elements. When the portable electronic device is placed on the wireless charger, the portable electronic device and the wireless charger are magnetically attracted by each other. Consequently, the induction coil can be precisely aligned with the magnetic field range of the wireless charging module, and the electric energy can be effectively converted and transmitted.

Generally, the magnetic element is used as an auxiliary tool for accurate alignment. However, not every portable electronic device has the magnetic element. That is, some kinds of portable electronic devices are capable of being wirelessly charged, but these portable electronic devices are not equipped with magnetic elements or not required to be aligned through magnetic attraction. The commercially available wireless chargers still have some drawbacks. For example, in case that the wireless charger has the built-in magnetic element, the magnetic element is fixed in the internal portion of the wireless charger and the magnetic element is unable to be simply disassembled and removed by the user. Whereas, in case that the wireless charger has no built-in magnetic element, the user cannot easily add the magnetic element into the wireless charger and simply disassemble or replace parts of the wireless charger. Since the conventional wireless charger cannot meet with the requirements of different types of portable electronic device, the conventional wireless charger is not user-friendly.

### SUMMARY OF THE INVENTION

For solving the drawbacks of the conventional technologies, the present invention provides a charger with movable parts. The charger includes a receiving recess for accommodating a magnetic assembly. A covering member of the charger can be easily detached and replaced. After the covering member is detached, the magnetic assembly can be changed or removed according to the user's requirements. The charger of the present invention can be applied to a variety of portable electronic devices. Since the magnetic attraction function or the non-magnetic attraction function is selectively achieved according to the practical requirements, the charger of the present invention can overcome the drawbacks of the conventional technologies.

In accordance with an aspect of the present invention, a charger with a removable magnetic assembly is provided. The charger includes a main body, a wireless charging module, a receiving recess and a covering member. The main body includes a top surface. The wireless charging module is disposed within the main body. The wireless charging module is permitted to provide electric energy to an external electronic device. The receiving recess is concavely formed in the top surface of the main body. The magnetic assembly is permitted to be accommodated within the receiving recess. The covering member is detachably disposed on the top surface of the main body. The covering member is detachably disposed on the top surface of the main body to cover the receiving recess. The covering member is selectively detached from or assembled with the top surface of the main body. When the covering member is detached from the top surface of the main body, the receiving recess is exposed outside, so that the magnetic assembly is selectively placed into the receiving recess or removed from the receiving recess.

In an embodiment, the magnetic assembly is aligned with the receiving recess. When the magnetic assembly is accommodated within the receiving recess, the main body provides a magnetic attraction force. When the magnetic assembly is removed from the receiving recess, the main body does not provide the magnetic attraction force.

In an embodiment, the external electronic device includes a magnetic element and a charging circuit. When the magnetic assembly is disposed within the receiving recess, the magnetic assembly is aligned with the magnetic element. Consequently, the external electronic device is magnetically attracted by the main body and the charging circuit is aligned with the wireless charging module.

In an embodiment, the main body further includes a first coupling element, and the covering member includes a second coupling element. The first coupling element is disposed on the top surface of the main body. The second coupling element is disposed on the covering member. When the first coupling element and the second coupling element are engaged with each other, the covering member is assembled with the top surface of the main body.

In an embodiment, when the covering member is disposed on the top surface of the main body and the receiving recess is covered by the covering member, the receiving recess is sealed by the covering member.

In an embodiment, the covering member includes a lower covering surface. The magnetic assembly is fixed on the lower covering surface and aligned with the receiving recess.

In an embodiment, the magnetic assembly includes a pedestal and at least one magnet. The at least one magnet is installed on the pedestal.

In an embodiment, the magnetic assembly is a ring-shaped magnetic assembly, and the receiving recess is a ring-shaped receiving recess.

In an embodiment, the wireless charging module is located near the top surface of the main body and located under the receiving recess.

In accordance with another aspect of the present invention, a charger with a removable magnetic assembly is provided. The charger includes a main body, a wireless charging module, a covering member and a receiving recess. The main body includes a top surface. The wireless charging module is disposed within the main body. The wireless charging module is permitted to provide electric energy to an external electronic device. The covering member includes a lower covering surface. The lower covering surface is aligned with the top surface of the main body. The covering member is detachably disposed on the top surface of the main body to cover the top surface of the main body. The receiving recess is concavely formed in the lower covering surface of the covering member. The covering member is selectively detached from or assembled with the top surface of the main body. When the covering member is detached from the top surface of the main body, the receiving recess is exposed outside. Consequently, the magnetic assembly is selectively placed into the receiving recess or removed from the receiving recess.

In an embodiment, the magnetic assembly is aligned with the receiving recess. When the magnetic assembly is accommodated within the receiving recess, the main body provides a magnetic attraction force. When the magnetic assembly is removed from the receiving recess, the main body does not provide the magnetic attraction force.

In an embodiment, the external electronic device includes a magnetic element and a charging circuit. When the magnetic assembly is disposed within the receiving recess, the magnetic assembly is aligned with the magnetic element. Consequently, the external electronic device is magnetically attracted by the main body and the charging circuit is aligned with the wireless charging module.

In an embodiment, the main body further includes a first coupling element, and the covering member includes a second coupling element. The first coupling element is disposed on the top surface of the main body. The second coupling element is disposed on the covering member. When the first coupling element and the second coupling element are engaged with each other, the covering member is assembled with the top surface of the main body.

In an embodiment, when the covering member is disposed on the top surface of the main body and the receiving recess is covered by the covering member, the receiving recess is sealed by the covering member.

From the above descriptions, the charger of the present invention has the special design for allowing the user to simply replace the inner parts. By changing the parts, the charger can selectively provide the magnetic attraction function or the non-magnetic attraction function.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating a charger according to a first embodiment of the present invention;

FIG. 2 is a schematic exploded view illustrating the charger according to the first embodiment of the present invention;

FIG. 3 is a schematic exploded view illustrating the charger according to the first embodiment of the present invention;

FIG. 4 is a schematic perspective view illustrating the structure of the magnetic assembly of the charger according to the first embodiment of the present invention;

FIG. 5 is a schematic exploded view illustrating the magnetic assembly as shown in FIG. 4;

FIG. 6 is a schematic cross-sectional view illustrating a scenario of using the charger without the magnetic assembly according to the first embodiment of the present invention;

FIG. 7 is a schematic cross-sectional view illustrating a scenario of using the charger with the magnetic assembly according to the first embodiment of the present invention;

FIG. 8 is a schematic exploded view illustrating a charger according to a second embodiment of the present invention; and

FIG. 9 is a schematic exploded view illustrating a charger according to a third embodiment of the present invention.

### DETAILED DESCRIPTION OF THE PREFERRED EMBODIMENT

The present invention will now be described more specifically with reference to the following embodiments and accompanying drawings.

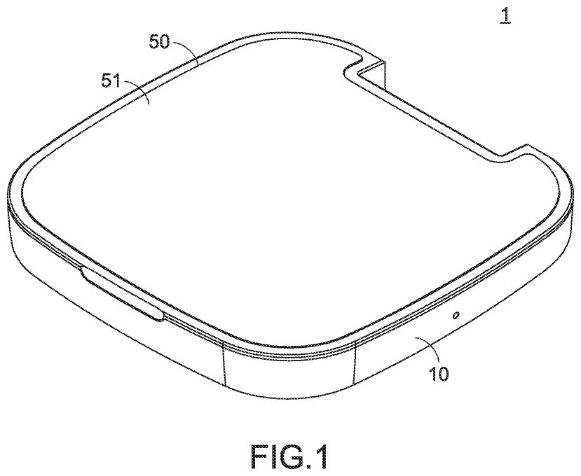

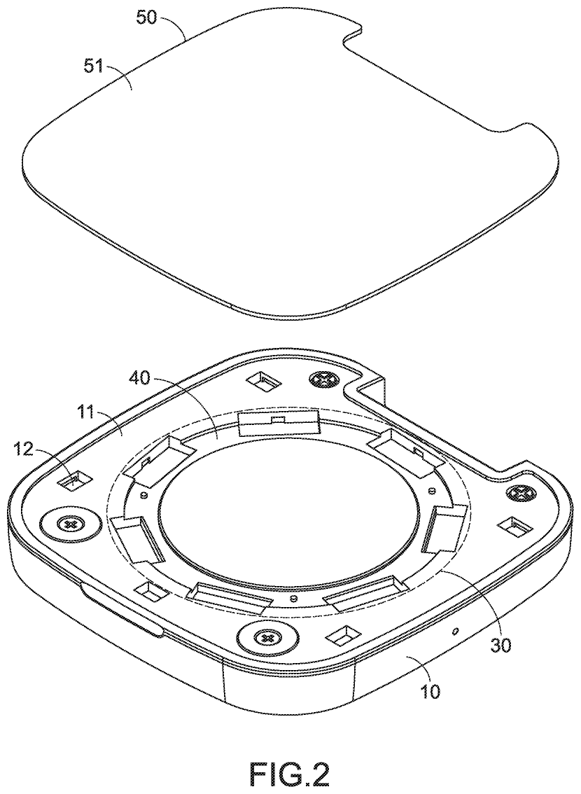

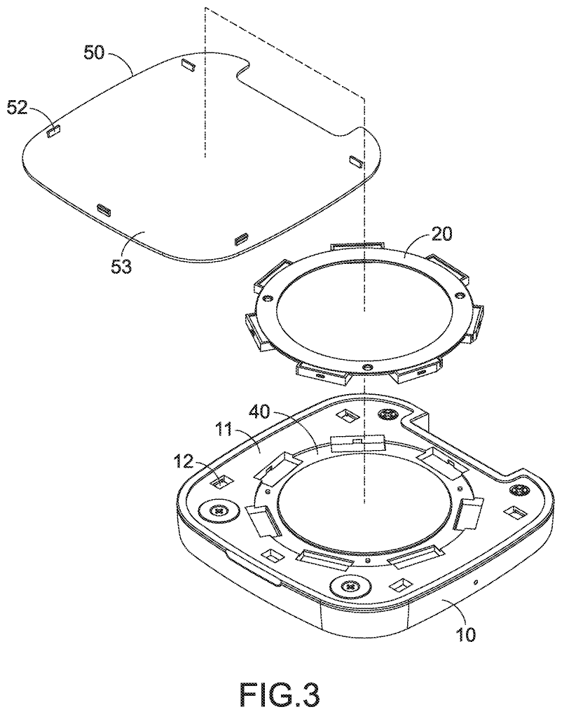

The present invention provides a charger with movable parts. The structure of a charger according to a first embodiment of the present invention will be illustrated with reference to FIGS. 1, 2 and 3. FIG. 1 is a schematic perspective view illustrating a charger according to a first embodiment of the present invention. FIG. 2 is a schematic exploded view illustrating the charger according to the first embodiment of the present invention. FIG. 3 is a schematic exploded view illustrating the charger according to the first embodiment of the present invention.

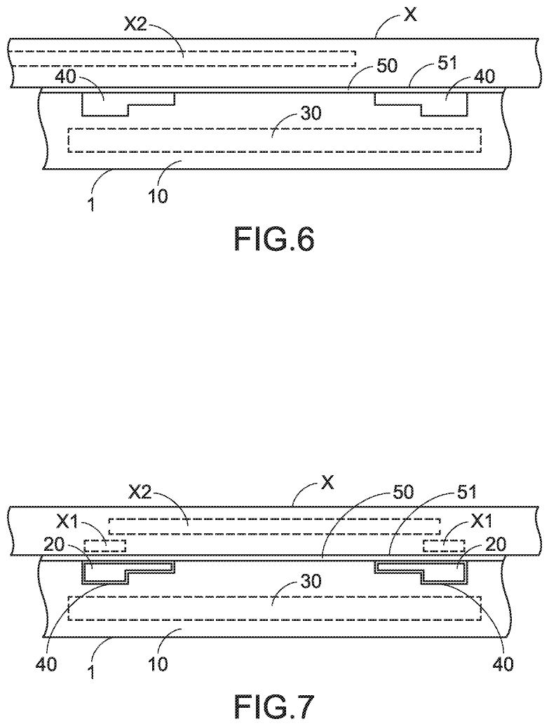

In this embodiment, the charger 1 can accommodate a magnetic assembly 20. The charger 1 comprises a main body 10, a wireless charging module 30, a receiving recess 40 and a covering member 50. The main body 10 has a top surface 11. The wireless charging module 30 is disposed within the main body 10. The wireless charging module 30 can provide electric energy to an external electronic device X (as shown in FIG. 6) through a wireless induction charging technology. The receiving recess 40 is concavely formed in the top surface 11 of the main body 10. In addition, the magnetic assembly 20 is accommodated within the receiving recess 40. The covering member 50 is detachably disposed on the top surface 11 of the main body 10. When the covering member 50 is disposed on the top surface 11 of the main body 10, the magnetic assembly 20 is covered by the covering member 50. When the covering member 50 is removed or detached from the top surface 11 of the main body 10, the receiving recess 40 is exposed to the surroundings. Consequently, the magnetic assembly 20 can be placed into the receiving recess 40 or removed from the receiving recess 40.

In an embodiment, the main body 10 of the charger 1 further comprises at least one first coupling element 12. The at least one first coupling element 12 is disposed on the top surface 11 of the main body 10. Moreover, the covering member 50 comprises an upper covering surface 51, at least one second coupling element 52 and a lower covering surface 53. The at least one second coupling element 52 is disposed on the lower covering surface 53. The at least one first coupling element 12 of the main body 10 is aligned with the at least one second coupling element 52 of the covering member 50. When the at least one first coupling element 12 and the at least one second coupling element 52 are engaged with each other, the covering member 50 is assembled with the top surface 11 of the main body 10.

The wireless charging module 30 is disposed within the main body 10. In addition, the wireless charging module 30 is located near the top surface 11 of the main body 10 and located under the receiving recess 40.

The magnetic assembly 20 is an independent component. In addition, the magnetic assembly 20 can be removed from the receiving recess 40 or placed into the receiving recess 40 according to the user's requirements. The size, shape and depth of the receiving recess 40 match the size, shape and thickness of the receiving recess 40. Consequently, the receiving recess 40 can be completely accommodated within the receiving recess 40.

The covering member 50 can be detached from or assembled with the top surface 11 of the main body 10 according to the user's requirements. When the covering member 50 is assembled with the top surface 11 of the main body 10, the receiving recess 40 is covered by the covering member 50. Since the receiving recess 40 is sealed by the covering member 50, the receiving recess 40 is not exposed to the surroundings. When the covering member 50 is removed or detached from the top surface 11 of the main body 10 by the user, the top surface 11 of the main body 10 is not sheltered by the covering member 50 and the receiving recess 40 is exposed to the surroundings. Under this circumstance, the user can place the magnetic assembly 20 into the receiving recess 40. After the magnetic assembly 20 is placed into the receiving recess 40, the covering member 50 is assembled with the top surface 11 of the main body 10 again. Consequently, the receiving recess 40 is covered by the covering member 50, and the magnetic assembly 20 is sealed in the receiving recess 40. In case that the magnetic assembly 20 is not required to be used, the user may open or remove the covering member 50 again. Consequently, the receiving recess 40 and the magnetic assembly 20 are exposed to the surroundings again. After the magnetic assembly 20 is removed from the receiving recess 40, and the covering member 50 is assembled with the top surface 11 of the main body 10 to cover the receiving recess 40. Under this circumstance, the magnetic assembly 20 is removed from the main body 10. Consequently, the purpose of removing and replacing the magnetic assembly 20 by the user freely can be achieved.

When the magnetic assembly 20 is accommodated or sealed within the receiving recess 40 and the top surface 11 of the main body 10 is covered by the covering member 50, the main body 10 provides a magnetic attraction force to magnetically attract the external electronic device X (see FIG. 6). At the same time, the external electronic device X (see FIG. 6) can be positioned on the upper covering surface 51 of the covering member 50 so as to be charged by the charger. In case that the magnetic assembly 20 is removed from the receiving recess 40 and the top surface 11 of the main body 10 is covered by the covering member 50, the main body 10 cannot provide the magnetic attraction force. Under this circumstance, the external electronic device X (see FIG. 6) can be placed on any position of the upper covering surface 51 of the covering member 50 so as to be charged by the charger.

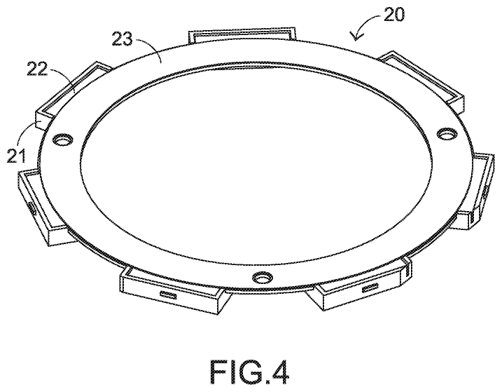

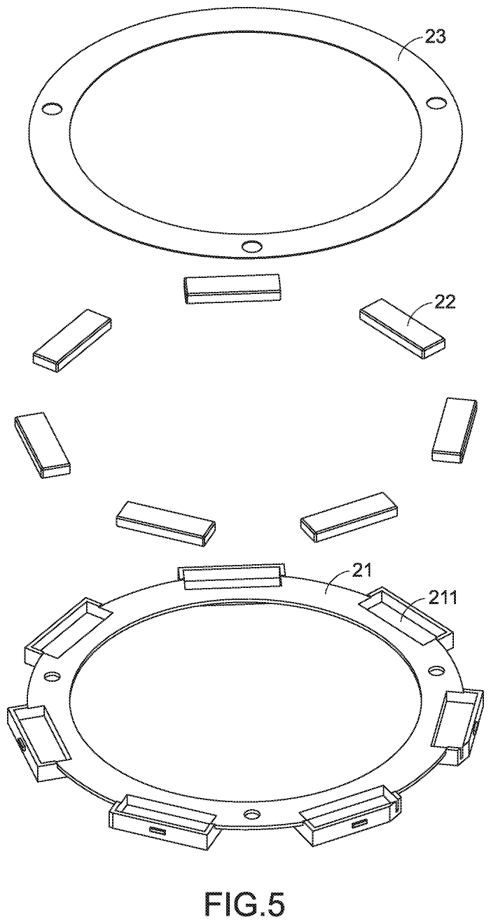

Hereinafter, the structure of the magnetic assembly 20 will be illustrated with reference to FIGS. 4 and 5. FIG. 4 is a schematic perspective view illustrating the structure of the magnetic assembly of the charger according to the first embodiment of the present invention. FIG. 5 is a schematic exploded view illustrating the magnetic assembly as shown in FIG. 4. The magnetic assembly 20 comprises a pedestal 21, at least one magnet 22 and a separation plate 23. The shape, size and height of the pedestal 21 match the receiving recess 40. The pedestal 21 comprises further comprises at least one magnet-receiving part 211. The number of the at least one magnet-receiving part 211 and the number of the at least one magnet 22 are equal. The at least one magnet 22 is accommodated within the corresponding magnet-receiving part 211 of the pedestal 21. The separation plate 23 is located over the at least one magnet 22 in order to protect the at least one magnet 22 and confine the at least one magnet 22 within the corresponding magnet-receiving part 211. The pedestal 21 can be accommodated within the receiving recess 40. That is, the at least one magnet 22 and the separation plate 23 along with the pedestal 21 are accommodated within the receiving recess 40. Consequently, when the magnetic assembly 20 is sealed within the receiving recess 40, the main body 10 provides the magnetic attraction force. In an embodiment, the at least one magnet 22 comprises plural magnets. The plural magnets 22 are arranged on the pedestal 21. In an embodiment, the plural magnets 22 are installed on the pedestal 21 in an adhering means or a clamping means, or the plural magnets 22 are integrally formed with the pedestal 21. In another embodiment, the plural magnets 22 are discretely arranged on a supporting plate (not shown) at a specified spacing interval and fixed on the specified positions of the supporting plate, and then the magnets 22 along with the supporting plate are disposed on the pedestal 21. In a preferred embodiment, the magnetic assembly 20 is a ring-shaped magnetic assembly, and the receiving recess 40 is a ring-shaped receiving recess. The plural magnets 22 are arranged on the ring-shaped pedestal 21 in a circular permutation. In addition, the ring-shaped pedestal 21 can be accommodated within the ring-shaped receiving recess 40.

Hereinafter, two usage scenarios of the charger 1 will be illustrated with reference to FIGS. 6 and 7. In a first usage scenario, the charger 1 is not equipped with the magnetic assembly 20. In a second usage scenario, the charger 1 is equipped with the magnetic assembly 20. FIG. 6 is a schematic cross-sectional view illustrating a scenario of using the charger without the magnetic assembly according to the first embodiment of the present invention. FIG. 7 is a schematic cross-sectional view illustrating a scenario of using the charger with the magnetic assembly according to the first embodiment of the present invention. The external electronic device X comprises a magnetic element X1 and a charging circuit X2. The magnetic element X1 and the charging circuit X2 are disposed within the external electronic device X. Due to the electromagnetic interaction between the wireless charging module 30 and the charging circuit X2, the charging circuit X2 generates an electricity to charge the external electronic device X. Due to the magnetic element X1, the external electronic device X is magnetically attracted and positioned on the charger 1.

Please refer to FIG. 6. In this usage scenario, the charger 1 is not equipped with the magnetic assembly 20. The receiving recess 40 of the charger 1 is covered by the covering member 50. Since the magnetic assembly 20 is not disposed within the receiving recess 40, the main body 10 cannot provide the magnetic attraction force. Under this circumstance, the external electronic device X can be placed on any position of the upper covering surface 51 of the covering member 50. Due to the electromagnetic interaction between the wireless charging module 30 and the charging circuit X2, the charging circuit X2 generates an electricity to charge the external electronic device X. However, since the magnetic attraction force is not generated between the external electronic device X and the main body 10 of the charger 1, the external electronic device X is usually unable to be precisely positioned on the charger 10 and aligned with the charging circuit X2. If the distance of the charging circuit X2 from the wireless charging module 30 is too far or the charging circuit X2 is not in the sensing range of the wireless charging module 30, the charging circuit X2 is unable to effectively sense the wireless charging module 30. Under this circumstance, the external electronic device X cannot be charged successfully.

Please refer to FIG. 7. In this usage scenario, the charger 1 is equipped with the magnetic assembly 20. The receiving recess 40 of the charger 1 is covered by the covering member 50. Since the magnetic assembly 20 is disposed within the receiving recess 40, the main body 10 can provide the magnetic attraction force. When the external electronic device X is placed on the upper covering surface 51 of the covering member 50, the magnetic element X1 is magnetically attracted by the magnetic assembly 20. Consequently, the external electronic device X is positioned on the main body 10 of the charger 10 and not readily shifted or detached. At the same time, the charging circuit X2 is precisely aligned with the wireless charging module 30 in the main body 10. In other words, the charging circuit X2 is continuously in the sensing range of the wireless charging module 30. Due to the electromagnetic interaction between the wireless charging module 30 and the charging circuit X2, the charging circuit X2 generates an electricity to charge the external electronic device X. Consequently, the charging performance is enhanced.

Generally, the magnetic element X1 is not an essential component of the external electronic device X. If the external electronic device X is not equipped with the magnetic element X1, it is not necessary to install the magnetic assembly 20 in the main body 10 of the charger 1. Whereas, if the external electronic device X is equipped with the magnetic element X1, the user may determine whether the magnetic assembly 20 is installed in the main body of the charger 1 or removed from the main body of the charger 1 according to the status of the external electronic device X.

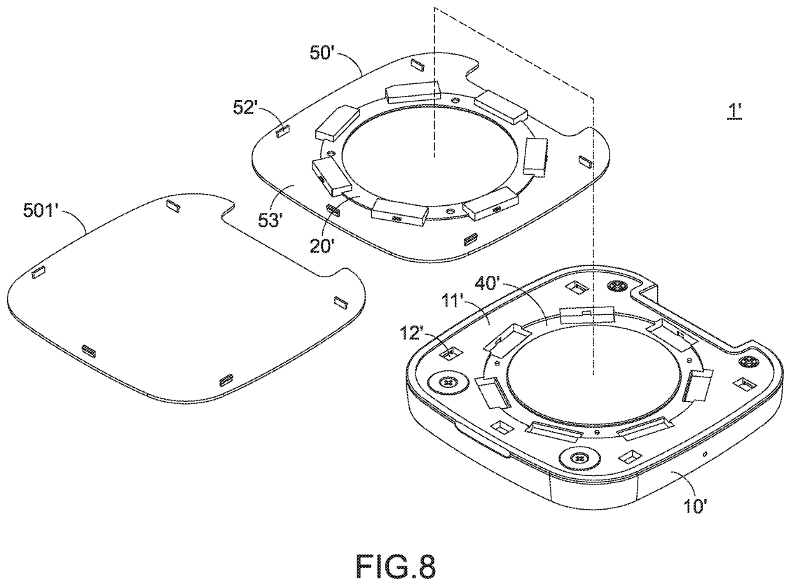

The structure of a charger according to a second embodiment of the present invention will be illustrated with reference to FIG. 8. FIG. 8 is a schematic exploded view illustrating a charger according to a second embodiment of the present invention. The structures and the usage scenarios of the charger 1′ which are similar to those of the first embodiment are not redundantly described herein. In this embodiment, the charger 1′ can accommodate a magnetic assembly 20′. The charger 1′ comprises a main body 10′, a wireless charging module (not shown), a receiving recess 40′ and a covering member 50′. The main body 10′ comprises a top surface 11′ and at least one first coupling element 12′. Moreover, the covering member 50′ comprises a lower covering surface 53′ and at least one second coupling element 52′. In this embodiment, the magnetic assembly 20′ is fixed on the lower covering surface 53′ of the covering member 50′. The wireless charging module (not shown) is disposed within the main body 10′. The receiving recess 40′ is concavely formed in the top surface 11′ of the main body 10′. In addition, the magnetic assembly 20′ is accommodated within the receiving recess 40′. The covering member 50′ is detachably disposed on the top surface 11′ of the main body 10′. The at least one second coupling element 52′ of the covering member 50′ is aligned with the at least one first coupling element 12′ of the main body 10′. When the at least one first coupling element 12′ and the at least one second coupling element 52′ are engaged with each other, the covering member 50′ is assembled with the main body 10′. When the covering member 50′ is disposed on the main body 10′ and the receiving recess 40′ is covered by the covering member 50′, the magnetic assembly 20′ fixed on the lower covering surface 53′ of the covering member 50′ is directly embedded into the receiving recess 40′ and sealed in the main body 10′. Consequently, the main body 10′ provides a magnetic attraction force.

In case that the magnetic assembly 20′ is not required to be used, the covering member 50′ may be replaced with another covering member 501′. The covering member 501′ is not equipped with the magnetic assembly 20′. When the covering member 501′ is disposed on the main body 10′, the magnetic assembly 20′ is not embedded into the receiving recess 40′. Under this embodiment, the main body 10′ cannot provide the magnetic attraction force. In other words, the covering member 50′ or the covering member 501′ can be selectively used in the charger 1′ of this embodiment according to the user's requirements.

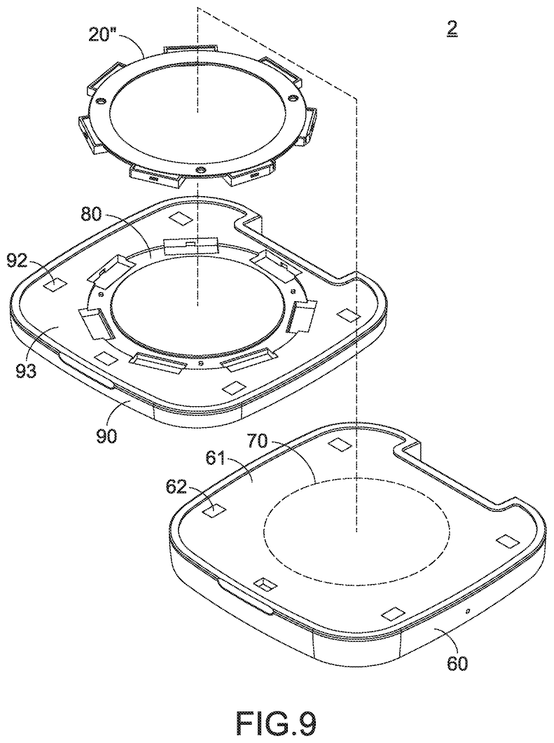

The structure of a charger according to a third embodiment of the present invention will be illustrated with reference to FIG. 9. FIG. 9 is a schematic exploded view illustrating a charger according to a third embodiment of the present invention. The structures and the usage scenarios of the charger 2 which are similar to those of the first embodiment are not redundantly described herein. In this embodiment, the charger 2 can accommodate a magnetic assembly 20″. The charger 1′ comprises a main body 60, a wireless charging module 70, a receiving recess 80 and a covering member 90. The main body 60 comprises a top surface 61 and at least one first coupling element 62. Moreover, the covering member 90 comprises at least one second coupling element 92 and a lower covering surface 93. The wireless charging module 30 is disposed within the main body 60. The receiving recess 80 is concavely formed in the lower covering surface 93 of the covering member 90. In addition, the magnetic assembly 20″ is accommodated within the receiving recess 80. The covering member 90 is detachably disposed on the main body 60. The lower covering surface 93 of the covering member 90 faces the top surface 61 of the main body 60. The at least one second coupling element 92 is aligned with the at least one first coupling element 62. When the at least one first coupling element 62 and the at least one second coupling element 92 are engaged with each other, the covering member 90 is assembled with the main body 60. When the covering member 90 is disposed on the main body 60, the receiving recess 80 in the covering member 90 is covered and sealed by the top surface 61 of the main body 60. Consequently, the covering member 90 can be selectively assembled with or detached from the top surface 61 of the main body 60 according to the user's requirements. When the covering member 90 is detached from the top surface 61 of the main body 60, the receiving recess 80 in the covering member 90 is exposed to the surroundings. Consequently, the magnetic assembly 20″ can be placed into the receiving recess 80 or removed from the receiving recess 80.

It is noted that the shape of the magnetic assembly 20, 20′ or 20″ is not restricted. That is, the shape, depth and installation position of the magnetic assembly 20, 20′ or 20″ may be varied according to the type of the charger. In addition, the way of connecting the first coupling element 12, 12′ or 62 with the second coupling element 52, 52′ or 92 is not restricted. For example, the first coupling element and the second coupling element may be connected with each other through a locking connection means, a magnetic connection means or an adhering means.

From the above descriptions, the present invention provides the charger. The charger can accommodate the magnetic assembly. Due to the structural design, the magnetic assembly can be easily placed into or removed from the charger. Consequently, the charger can selectively provide the magnetic attraction force according to the user's requirements. Since the charger can be applied to a variety of external electronic device, the charger is user-friendly. In addition, the wireless charge sensing performance and the positioning performance are enhanced.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. A charger with a removable magnetic assembly, the charger comprising:
a main body comprising a top surface;
a wireless charging module disposed within the main body, wherein the wireless charging module is permitted to provide electric energy to an external electronic device;
a receiving recess concavely formed in the top surface of the main body, wherein the magnetic assembly is permitted to be accommodated within the receiving recess; and
a covering member detachably disposed on the top surface of the main body, wherein the covering member is detachably disposed on the top surface of the main body to cover the receiving recess,
wherein the covering member is selectively detached from or assembled with the top surface of the main body, wherein when the covering member is detached from the top surface of the main body, the receiving recess is exposed outside, so that the magnetic assembly is selectively placed into the receiving recess or removed from the receiving recess.

2. The charger according to claim 1, wherein the magnetic assembly is aligned with the receiving recess, wherein when the magnetic assembly is accommodated within the receiving recess, the main body provides a magnetic attraction force, wherein when the magnetic assembly is removed from the receiving recess, the main body does not provide the magnetic attraction force.

3. The charger according to claim 1, wherein the external electronic device comprises a magnetic element and a charging circuit, wherein when the magnetic assembly is disposed within the receiving recess, the magnetic assembly is aligned with the magnetic element, so that the external electronic device is magnetically attracted by the main body and the charging circuit is aligned with the wireless charging module.

4. The charger according to claim 1, wherein the main body further comprises a first coupling element, and the covering member comprises a second coupling element, wherein the first coupling element is disposed on the top surface of the main body, and the second coupling element is disposed on the covering member, wherein when the first coupling element and the second coupling element are engaged with each other, the covering member is assembled with the top surface of the main body.

5. The charger according to claim 1, wherein when the covering member is disposed on the top surface of the main body and the receiving recess is covered by the covering member, the receiving recess is sealed by the covering member.

6. The charger according to claim 1, wherein the covering member comprises a lower covering surface, wherein the magnetic assembly is fixed on the lower covering surface and aligned with the receiving recess.

7. The charger according to claim 1, wherein the magnetic assembly comprises a pedestal and at least one magnet, wherein the at least one magnet is installed on the pedestal.

8. The charger according to claim 1, wherein the magnetic assembly is a ring-shaped magnetic assembly, and the receiving recess is a ring-shaped receiving recess.

9. The charger according to claim 1, wherein the wireless charging module is located near the top surface of the main body and located under the receiving recess.

10. A charger with a removable magnetic assembly, the charger comprising:
a main body comprising a top surface;
a wireless charging module disposed within the main body, wherein the wireless charging module is permitted to provide electric energy to an external electronic device;
a covering member comprising a lower covering surface, wherein the lower covering surface is aligned with the top surface of the main body, and the covering member is detachably disposed on the top surface of the main body to cover the top surface of the main body; and
a receiving recess concavely formed in the lower covering surface of the covering member,
wherein the covering member is selectively detached from or assembled with the top surface of the main body, wherein when the covering member is detached from the top surface of the main body, the receiving recess is exposed outside, so that the magnetic assembly is selectively placed into the receiving recess or removed from the receiving recess.

11. The charger according to claim 10, wherein the magnetic assembly is aligned with the receiving recess, wherein when the magnetic assembly is accommodated within the receiving recess, the main body provides a magnetic attraction force, wherein when the magnetic assembly is removed from the receiving recess, the main body does not provide the magnetic attraction force.

12. The charger according to claim 10, wherein the external electronic device comprises a magnetic element and a charging circuit, wherein when the magnetic assembly is disposed within the receiving recess, the magnetic assembly is aligned with the magnetic element, so that the external electronic device is magnetically attracted by the main body and the charging circuit is aligned with the wireless charging module.

13. The charger according to claim 10, wherein the main body further comprises a first coupling element, and the covering member comprises a second coupling element, wherein the first coupling element is disposed on the top surface of the main body, and the second coupling element is disposed on the covering member, wherein when the first coupling element and the second coupling element are engaged with each other, the covering member is assembled with the top surface of the main body.

14. The charger according to claim 10, wherein when the covering member is disposed on the top surface of the main body and the receiving recess is covered by the covering member, the receiving recess is sealed by the covering member.
